(19) United States
(12) Patent Application Publication
(10) Pub. No.: US 2002/0067728 A1
(43) Pub. Date: Jun. 6, 2002

(54) Route guidance service using the internet

(75) Inventor: Yasuharu Okamoto, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/987,556

(22) Filed: Nov. 15, 2001

(30) Foreign Application Priority Data
Dec. 4, 2000 (JP) 2000-368721

(51) Int. Cl. H04L 12/56

(52) U.S. Cl. 370/395.2; 370/395.52

(57) ABSTRACT

A route guidance device is provided that directs a user to an optimum route according to changing traffic conditions. The route guidance device includes a map information storage unit, a site information storage unit, a site-to-site information storage unit, a site information-receiving unit, a site-to-site information input unit, and an optimum route extraction unit. The map information storage unit stores in advance map information that includes information regarding distances along roads on a map and the time required to travel on these roads. The site information-receiving unit receives from a user terminal, via the Internet, site information which is information indicating a plurality of sites that are to be visited, and stores the received site information in the site information storage unit. The site-to-site information input unit obtains, via the Internet site-to-site information that includes information regarding real-time traffic conditions of roads and stores the obtained site-to-site information in the site-to-site information storage unit. The optimum route extraction unit extracts optimum routes for traveling to a plurality of sites in the shortest time or by the shortest distance based on the map information, the site information, and the site-to-site information, and sends the extracted optimum route information to the user terminal.

### BACKGROUND OF THE INVENTION

1. Field of the Invention

The present invention relates to a method of offering a service by using the Internet, and more particularly to a method of offering a route guidance service to offer to users via the Internet optimum routes for vehicular travel in real time.

2. Description of the Related Art

Services offering delivery by automobiles or motorcycles have come into common use. Because this service involves delivering articles to a plurality of locations by a vehicle, the efficiency of the delivery varies considerably according to the delivery route. Efficient routing not only allows a savings in time, but also reduces the amount of vehicle fuel that is consumed.

A wide variety of businesses offer delivery by truck or delivery of articles by automobiles, and in addition to delivery, many businesses and services involve travel to a plurality of locations, such as business sales services that make the rounds of customers by automobile or advertising and publicity operations, electioneering activities, and home care services that travel over large areas by automobile.

One method of the prior art for obtaining an efficient route for visiting a plurality of sites is a method in which the shortest distance between given points is calculated based on information that has been registered in advance, such as in an onboard navigation device.

This method enables a route to be obtained for visiting a plurality of sites by the shortest distance.

With the popularization and widespread use of the Internet in recent years, a wide variety of information is now offered to the public over the Internet, and a wide variety of services can also be offered. In addition, various businesses have been created for offering information and services over the Internet.

Given these circumstances, map information and route information are being offered over the Internet. One form of this information that is offered over the Internet is a map of the vicinity of a destination that is posted so as to allow viewing on a home page. A user is thus able to view a map of the vicinity of a destination by applying conditions of the destination as input to a personal computer.

The optimum route to a destination can change from minute to minute due to traffic conditions such as accidents or naturally occurring traffic congestion as well as blocked traffic or alternating one-way traffic due to roadwork.

Methods of the prior art in which an optimum route is calculated based on information that has been registered in advance cannot cope with such changes in traffic conditions because calculations are based on registered information, and this method therefore will not necessarily provide the optimum route for a particular point in time.

In order to obtain the optimum route based on information that is offered over the Internet, the driver must estimate the optimum route from map information based on his or her own experience. However, traffic conditions cannot be obtained from map information, and inevitably, there is no guarantee that the ideal route at a particular time can be obtained.

In order to obtain the optimum route for a particular time, a route that is obtained by the above-described methods must be modified based on traffic information from the radio, and getting the optimum route therefore requires knowledge that is obtained only through experience.

Finally, it was impossible in the above-described methods of the prior art to ascertain whether or not a determined route was in fact the optimum route.

### SUMMARY OF THE INVENTION

It is an object of the present invention to provide a route guidance method, system and device that direct a user in real time to the optimum route according to changing traffic conditions.

To achieve the above-described object, according to the route guidance method of the present invention, map information including information regarding the distances along roads on a map or the time required to travel on these roads is stored in advance, and via the Internet both site information, which is information indicating a plurality of sites that are to be visited, and site-to-site information, which includes real-time information on traffic conditions of roads, are obtained and stored in a storage medium. A route by which a plurality of sites can be visited in the shortest time or by shortest distance are then extracted as an optimum route based on the map information, site information, and site-to-site information. The extracted optimum route is then reported to the user by way of the Internet.

A user can thus easily obtain in real time a route for visiting a plurality of sites in the shortest time or by shortest distance according to traffic conditions at that point in time.

The above and other objects, features, and advantages of the present invention will become apparent from the following description based on the accompanying drawings, which illustrate examples of preferred embodiments of the present invention.

### BRIEF DESCRIPTION OF THE DRAWINGS

FIG. 1 is a block diagram of a route guidance system according to an embodiment of the present invention;

FIG. 2 is a block diagram showing the configuration of a route guidance device according to this embodiment;

FIG. 3 is a sequence chart showing an example of the operation of the route guidance system of this embodiment;

FIG. 4 shows an example of site information;

FIG. 5 shows an example of site-to-site information;

FIG. 6 is a flow chart showing the progression of processing of the route guidance device;

FIG. 7 is a flow chart showing the operation of a route guidance system;

FIG. 8 shows an example of site information that includes predicted work time at each site;

FIG. 9 shows an example of site information that includes information indicating whether articles are to be delivered or collected at each point;

FIG. 10 shows an example of site information that includes designated priorities for the delivery of articles at each site;

FIG. 11 shows an example of site information that gives article attributes that include the size, weight, and degree of value of articles to be delivered at each site;

FIG. 12 shows an example of the content of site information that includes information regarding times of absence;

FIG. 13 shows an example of site information that includes customer request conditions for each site;

FIG. 14 is a sequence chart showing an example of the updating operation-of site-to-site information for a case in which site-to-site information is periodically updated; and

FIG. 15 is a sequence chart showing an example of the operation of extracting the ideal route for a case in which site-to-site information is periodically updated.

### DETAILED DESCRIPTION OF THE PREFERRED EMBODIMENTS

The present invention implements a service that extracts optimum routes when a plurality of sites designated from the user are to be visited and provides the extracted optimum routes to the user by way of the Internet.

Although a variety of businesses and operations involve traveling to a plurality of sites, the following embodiment is described taking as an example the delivery of articles by a home delivery business. In this example, the plurality of sites on the route are all within the delivery area of a business office to which the traveler belongs, and the traveler travels by automobile by way of predetermined route sites and delivers articles at each site. Some of the articles have designated delivery time blocks during which the articles should be delivered. The traffic conditions within the delivery area are in a state of constant change and the amount of time required for travel over a route therefore varies even for the same route according to the time of travel.

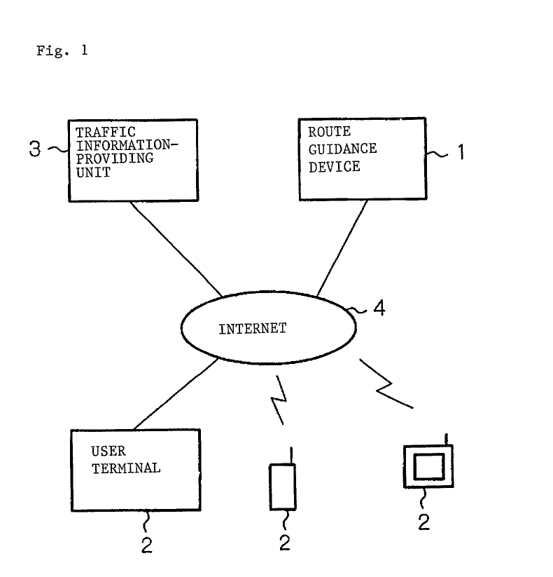

Referring now to FIG. 1, there is shown a route guidance system according to an embodiment of the present invention comprising route guidance device 1, user terminal 2, and traffic information-providing device 3. Route guidance device 1, user terminal 2, and traffic information-providing device 3 are connected by way of Internet 4 to enable transmission and reception of data among these components.

User terminal 2 is a personal computer, a portable telephone, or portable information terminal (Personal Digital Assistant (PDA)) used by a traveler or a person creating a plan of a travel route (hereinbelow referred to as the user) and is capable of accessing route guidance device 1 to send and receive data over Internet 4 and to display data.

Traffic information-providing device 3 is an existing device that provides, by way of Internet 4, information on traffic conditions such as traffic blockages, alternating one-way traffic, or traffic congestion.

Route guidance device 1 extracts a route by which a plurality of sites that have been designated by the user can be visited in the shortest time or by shortest distance and provides the route to the user.

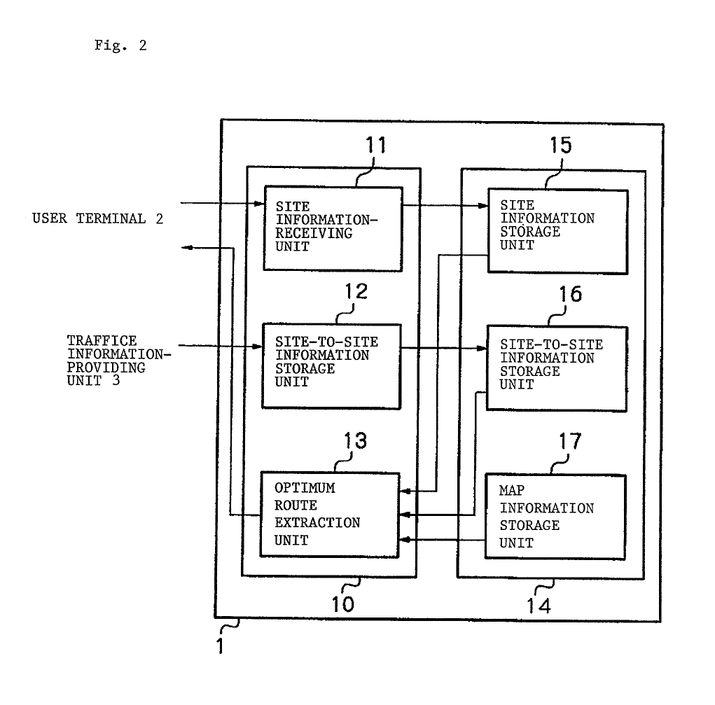

Referring to FIG. 2, route guidance device 1 includes processor 10 and storage unit 14. Processor 10 includes site information-receiving unit 11, site-to-site information input unit 12, and optimum route extraction unit 13. Storage unit 14 includes site information storage unit 15, site-to-site information storage unit 16, and map information storage unit 17.

Site information storage unit 15 stores, as site information, information that includes the location of departure of user terminal 2 and a plurality of route sites that have been designated by the user.

Site-to-site information storage unit 16 stores, as site-to-site information, traffic conditions of roads such as traffic blockages, alternating one-way traffic, and traffic congestion.

Map information storage unit 17 stores in advance map information of the entire area within the delivery area. Map information includes distance information for calculating the distance between two sites and time information regarding the time to travel between two sites.

Site information-receiving unit 11 receives site information from user terminal 2 and stores this information in site information storage unit 15.

Site-to-site information input unit 12 accesses traffic information-providing device 3, receives site-to-site information, and stores this information in site-to-site information storage unit 16.

Optimum route extraction unit 13 reads site information and site-to-site information from site information storage unit 15 and site-to-site information storage unit 16, respectively, and extracts the route having the shortest time and the route having the shortest distance while referring to the map information of map information storage unit 17 to send the extracted information to user terminal 2 as optimum route information. The optimum route information that is received at user terminal 2 is displayed on a screen.

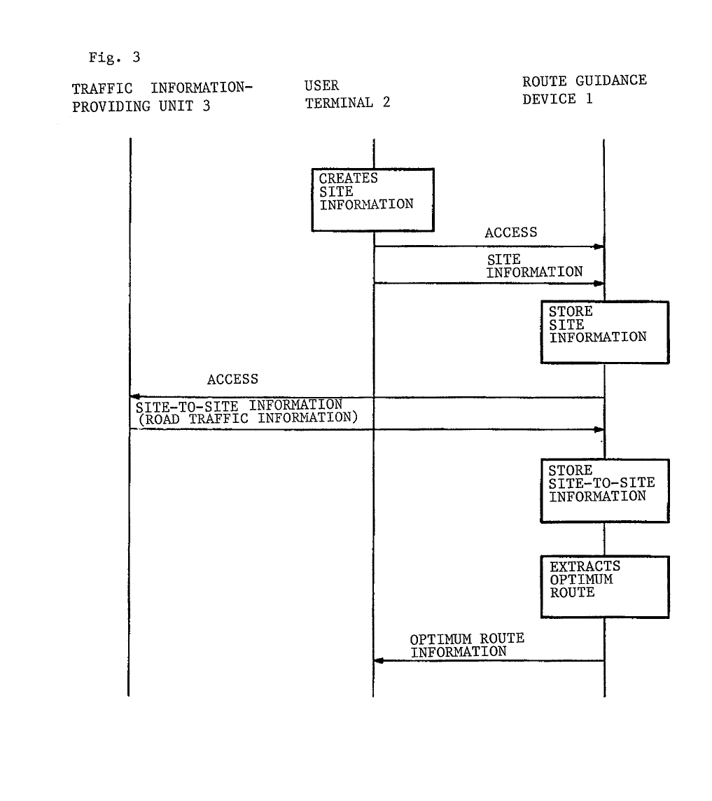

The operation of the route guidance system of the present embodiment will next be explained with reference to FIGS. 3 to 6.

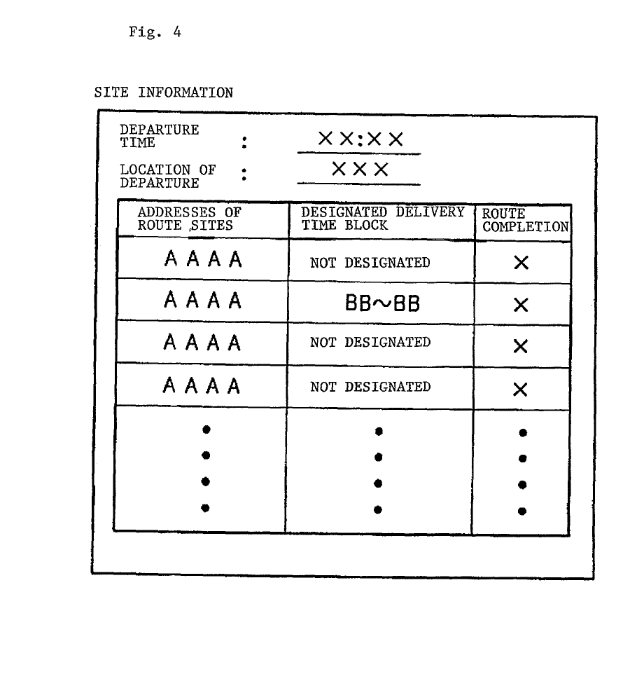

Referring first to FIG. 3, the user uses user terminal 2 to access route guidance device 1, creates site information in accordance with the screen, and sends the information to route guidance device 1. As shown in FIG. 4, the site information includes information regarding the departure time, the location of departure, the addresses of a plurality of route sites, designated delivery time blocks for each route site, and information indicating whether or not a delivery has been made.

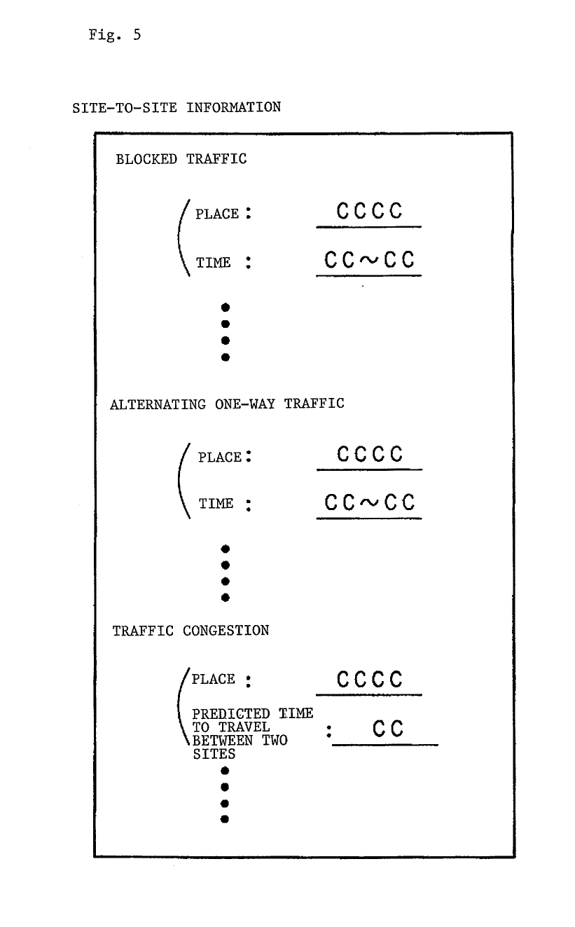

In route guidance device 1, the site information is received at site information-receiving unit 11 and stored in site information storage unit 15. Site-to-site information input unit 12 of route guidance device 1 accesses traffic information-providing device 3 by way of Internet 4, obtains site-to-site information, and stores the site-to-site information in site-to-site information storage unit 16. As shown in FIG. 5, site-to-site information includes information regarding blocked traffic, information regarding alternating one-way traffic, and information regarding traffic congestion.

Route guidance device 1 next extracts the shortest time route and the shortest distance route in optimum route extraction unit 13.

Distance information that is included in the map information is used when extracting the shortest distance route in optimum route extraction unit 13. If a traffic blockage is included within the route at this time, the route is excluded. On the other hand, when extracting the shortest time route in optimum route extraction unit 13, time information in the map information is used in calculating travel time and a prescribed time that has been set in advance is used as the work time at each site. At this time, routes having traffic blockages are excluded, and the required time is revised if there is alternating one-way traffic or traffic congestion. The required time is taken as, for example, three times the normal time for alternating one-way traffic and five times the normal time for traffic congestion. Revision for traffic congestion may be carried out using a plurality of stages depending on the severity of the traffic congestion. In addition, if a delivery time block has been set for a route site, routes are excluded if travel by that route results in a time of arrival at that site that is outside the designated delivery time block.

After the shortest time route and shortest distance route have been extracted, this information is sent as optimum route information from route guidance device 1 to user terminal 2. The optimum route information is displayed on a screen at user terminal 2, and the user begins travel based on the optimum route information that is displayed on the screen of user terminal 2. User terminal 2 may store map information within the delivery area beforehand. In such a case, the shortest time route and shortest distance route can be displayed together with a map on the screen of user terminal 2. Alternatively, map information may be included in the optimum route information. In this case as well, the shortest time route and shortest distance route can be displayed together with a map on the screen of user terminal 2.

The optimum route information includes the shortest time route and the shortest distance route, the shortest time route enabling a saving of time and the shortest distance route enabling a saving of vehicle fuel. The user can choose either of these routes.

When the user has arrived at the next site and has completed the work at that site, the user again uses user terminal 2 to access route guidance device 1 and extract optimum routes. The user subsequently extracts the optimum routes again in the same way at each site upon completing delivery at that site.

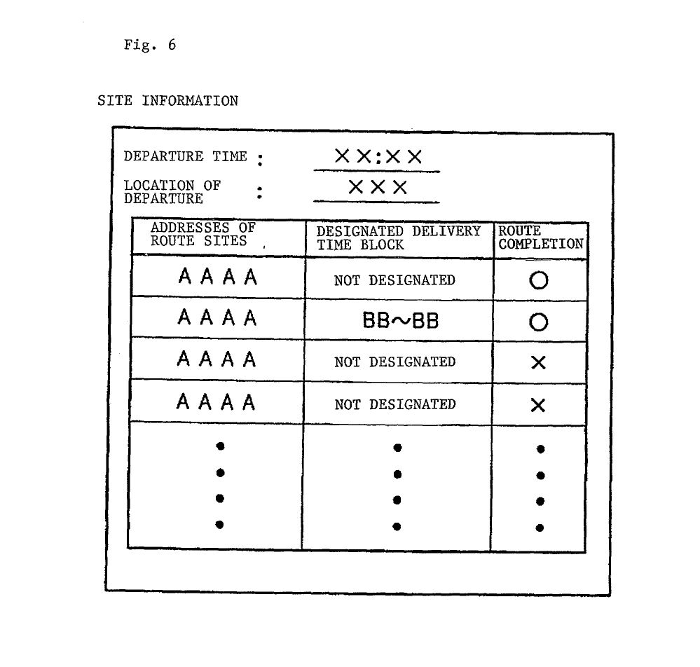

FIG. 6 shows an example of site information that is provided to route guidance device 1 from user terminal 2 when re-extracting the optimum routes. In FIG. 6, route sites in which “◯” is entered in the “route completion column” are sites that have already been visited. Site information (FIG. 4) that has been provided to route guidance device 1 previously can be revised and used.

When site information such as shown in FIG. 4 is provided from user terminal 2 to route guidance device 1, route guidance device 1 extracts the optimum route for traveling to sites that have not yet been visited.

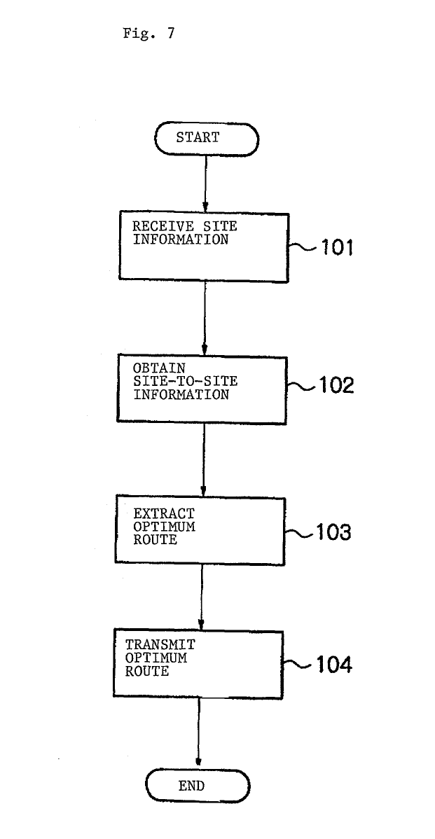

FIG. 7 illustrates a flow chart showing the operations of route guidance device 1.

At Step 101, site information from user terminal 2 is received by site information-receiving unit 11. Then, at Step 102, site-to-site information input unit 12 accesses traffic information providing device 3 to obtain site-to-site information. The site information and site-to-site information are stored in site information storage unit 15 and site-to-site information storage unit 16, respectively. At Step 103, optimum route extraction unit 13 extracts the optimum routes based on the site information, site-to-site information, and map information stored in map information storage unit 17. At Step 104, optimum route extraction unit 13 sends the optimum route information to user terminal 2.

According to the route guidance system of the present embodiment, when a user uses user terminal 2 to access route guidance device 1 by way of Internet 4 and applies site information as input, site-to-site information is obtained from traffic information providing device 3 at route guidance device 1, the shortest time route and shortest distance route are extracted based on site information, site-to-site information, and pre-recorded map information, and these routes are reported to user terminal 2 by way of Internet 4. The optimum routes according to conditions at that point in time can thus be obtained in real time and travel in the shortest time or by the shortest route can be facilitated.

In the present embodiment, the user does not need to again extract the optimum route at each site. That is, if the user must again travel to the same delivery site because a recipient was not in or if traffic conditions of roads have changed, the user may re-extract the optimum routes and modify his plan as necessary.

Rather than a device of an already existing web-site, traffic information-providing device 3 in the present embodiment may be a device for the exclusive use of this system that provides information by way of Internet 4 regarding traffic blockages, alternating one-way traffic, or traffic congestion.

User terminal 2 may be a device capable of detecting its own position such as a portable telephone that incorporates a GPS receiver or a PHS terminal that is capable of obtaining positional information from a communication system. In such cases, when the current location is used as the location of departure, user terminal 2 itself automatically obtains positional information and describes it in the site information, thereby relieving the user of the need to input the location of departure.

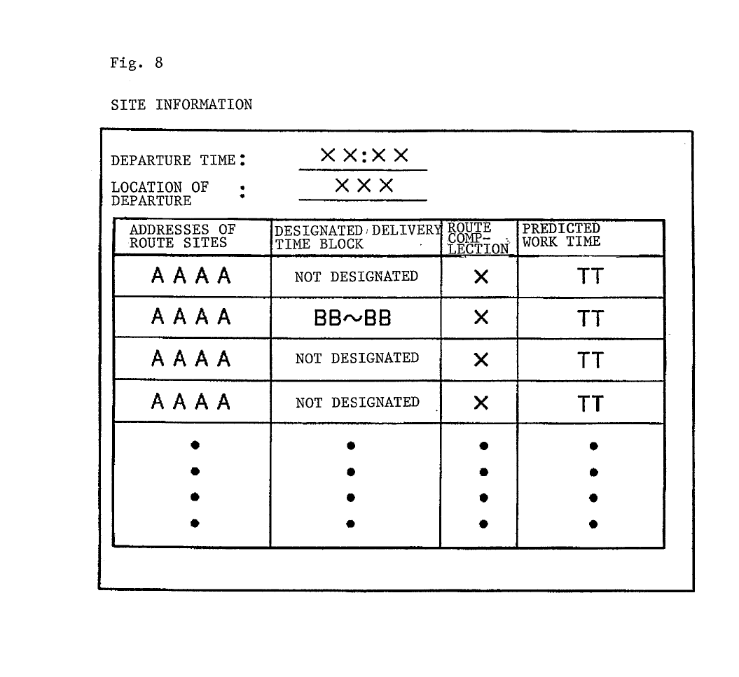

Site information may further include the predicted work time at each site, as shown in FIG. 8. The predicted work time is applied as input from user terminal 2, transmitted to route guidance device 1 from user terminal 2, and stored corresponding to each site in site information storage unit 15. In this case, the use of the predicted work time of each site to calculate the travel time raises the accuracy of the calculated travel time.

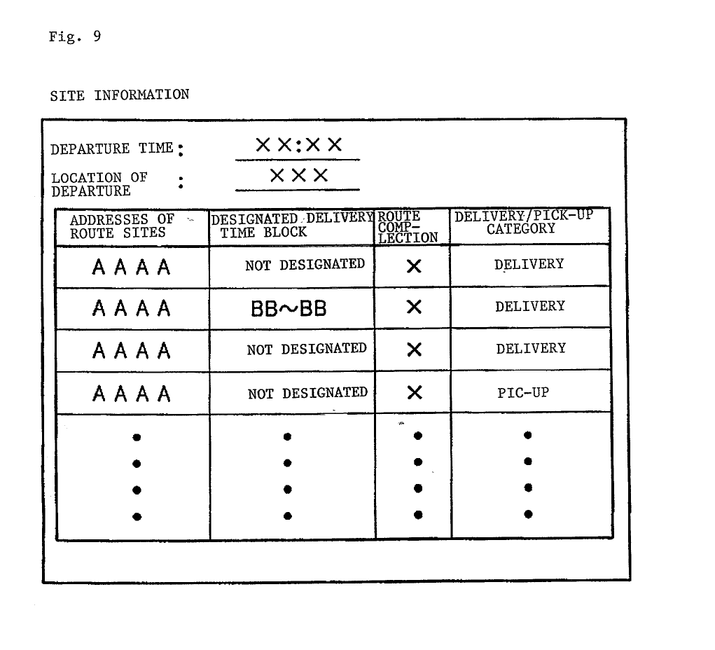

When articles are picked up as well as delivered, the site information may include information indicating whether articles are to be delivered or picked up at each site, as shown in FIG. 9. The delivery/pick-up category is applied as input from user terminal 2, transmitted from user terminal 2 to route guidance device 1, and stored corresponding to each site in site information storage unit 15.

When a full load of articles at departure leaves no empty cargo space, work must begin with deliveries. In such cases, a route may be selected in route guidance device 1 using the delivery/pick-up category such that delivery work is given priority, thereby eliminating the problem of lack of cargo space for articles that are to be picked up.

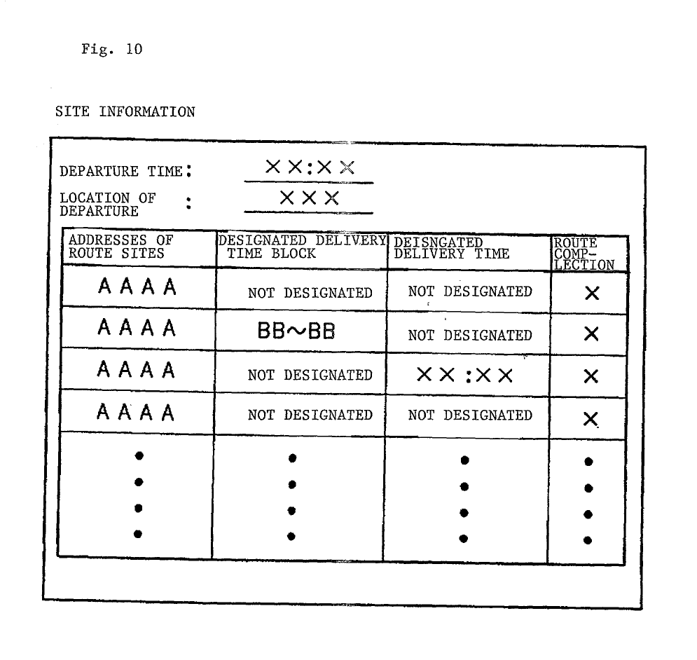

As shown in FIG. 10, the site information may also include designated delivery times for articles that are to be delivered at each site. Designated delivery times are applied as input from user terminal 2, sent from user terminal 2 to route guidance device 1, and stored corresponding to each site in site information storage unit 15. Designated delivery times are times designated when articles must be delivered precisely at a prescribed time. In this case, the user arrives at the site before the designated delivery time and waits until the designated delivery time. By setting this condition and optimizing the delivery route, route guidance device 1 enables efficient routing that carefully observes delivery times that are designated by customers.

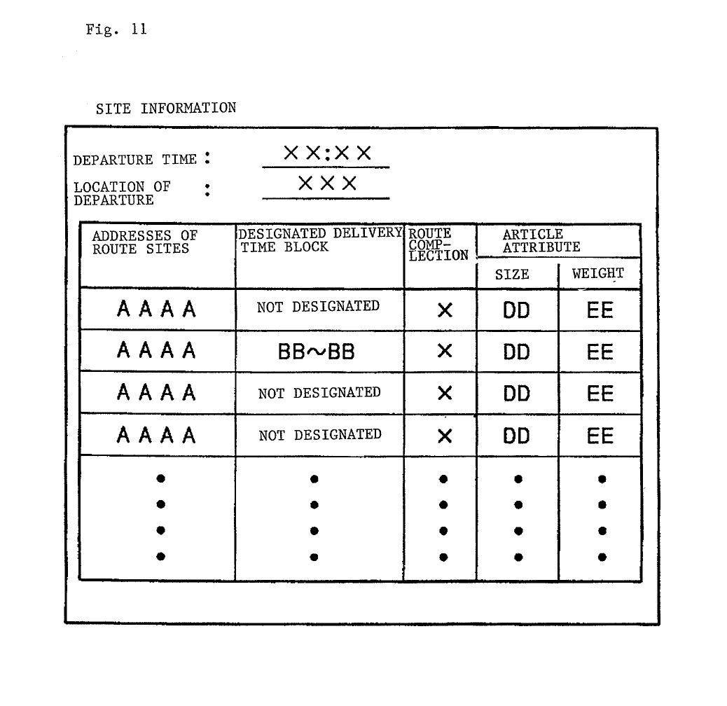

As shown in FIG. 11, site information may also be given article attributes that include the size and weight of articles that are to be delivered at each site. Article attributes are applied as input from user terminal 2, sent from user terminal 2 to route guidance device 1, and stored corresponding to each site in site information storage unit 15. When there are sites at which articles are to be picked up, the use of article attributes allows determination at route guidance device 1 of whether articles can be picked up or not, thereby eliminating the possibility when making a visit based on optimum route information that articles cannot be picked up because of a lack of free cargo space or because the load limit of the vehicle has been exceeded.

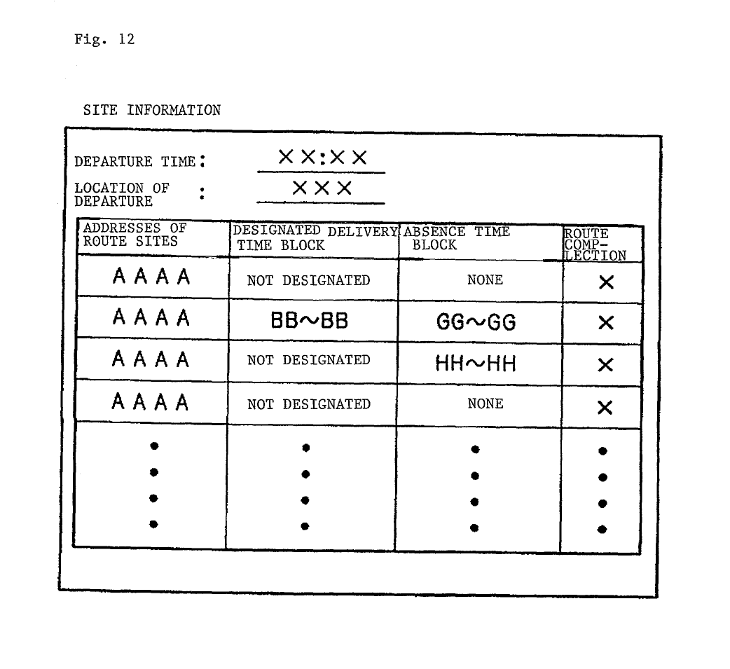

The site information may also include absence time block information as shown in FIG. 12 when a time block is known in advance during which no one will be in at a site. An absence time block is applied as input from user terminal 2, transmitted from user terminal 2 to route guidance device 1, and stored corresponding to each site in site information storage unit 15. When extracting optimum routes in such a case, routes in which an arrival time at a site falls within an absence time block of that site are excluded, thereby enabling efficient travel that avoids visits during the absence of recipients.

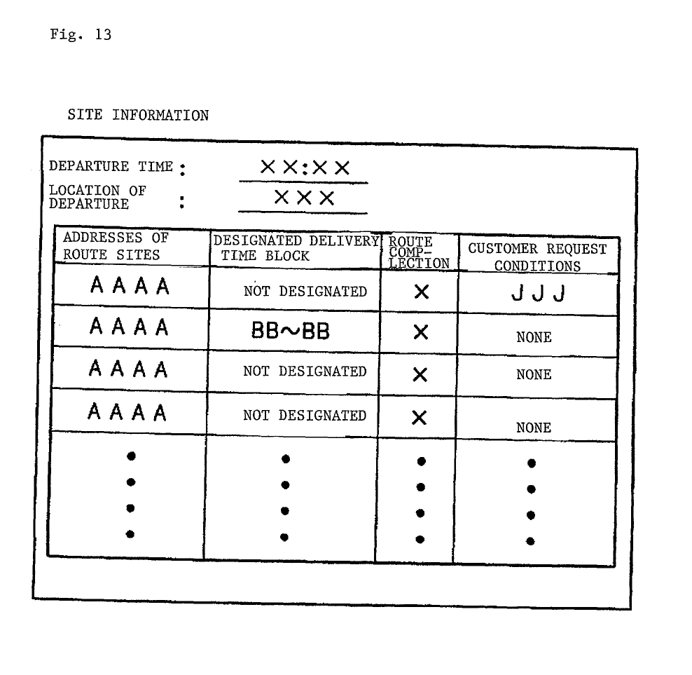

Site information may further be provided with customer request conditions for each site as shown in FIG. 13. Customer request conditions are communicated from a recipient that is absent to the delivery pick-up center by, for example, telephone, and then communicated to, for example, the portable telephone of the delivery person. These customer request conditions are applied as input from user terminal 2, transmitted from user terminal 2 to route guidance device 1, and stored corresponding to each site in site information storage unit 15. A customer request condition is information for requesting re-delivery from an absent recipient and may include a designated delivery time block or a designated delivery time. Route guidance device 1 can re-optimize the delivery route to include a customer request condition, thereby enabling an improvement in customer service and a more efficient delivery operation.

Site-to-site information may also include weather conditions. In this case, weather information is used to revise the time to travel between two sites when calculating travel time, thereby reducing discrepancies in travel time that are caused by weather. For example, because the time to travel between sites can be expected to increase during inclement weather, a uniform 30% increase of travel time can be considered. This weather information may be applied as input from user terminal 2, or information provided on Internet 4 may be used. When information provided on Internet 4 is used, route guidance device 1 automatically accesses a site that provides this information to obtain weather information.

Site-to-site information may further include predicted travel times of major roads. The predicted travel time is used as a travel time between two sites. The predicted travel time may be applied as input from user terminal 2, or information provided on Internet 4 may be used. When information provided on Internet 4 is used, route guidance device 1 automatically accesses a site that provides the information to obtain information on predicted travel times. Since real-time information is used as the predicted travel time for major roads in this case, the accuracy in calculating the route travel time can be increased.

Site-to-site information may further include event information. Event information include information regarding time blocks in which roads are blocked or traffic regulated for such events as marathons and parades, which information are considered when extracting routes. Since routes can thus be extracted that do not pass via blocked roads or roads in which traffic flow is limited, the extracted routes can be reliably traveled. For example, routes are excluded that pass by way of roads that are blocked by a marathon during certain time blocks.

The site information stored in site information storage unit 15 and the site-to-site information stored in site-to-site information storage unit 16 may be used not only in extracting a route at a particular time but in extracting routes at a subsequent time.

A route that minimizes the amount of fuel such as gasoline of an automobile may be extracted as the optimum route. A plurality of vehicles of the same type are typically used in a delivery service, and a standard amount of fuel can be set for a particular distance. Information on the standard fuel consumption on main roads may also be included in the site-to-site information. For example, past fuel consumption on main roads can be recorded and standard fuel consumption then calculated using an average of this past consumption.

Route guidance device 1 adds a correction to the standard fuel consumption on a congested road to thereby predict fuel consumption. Route guidance device 1 may also revise fuel consumption according to the load being carried at a particular time. Routes can thus be directed to roads on which fuel consumption is at a minimum, thereby enabling a saving in fuel. The amount of exhaust gases such as CO₂ can also be reduced to mitigate harmful effects on the environment.

In the present embodiment, route guidance device 1 may also periodically access traffic information providing device 3 to obtain site-to-site information even when not extracting optimum routes.

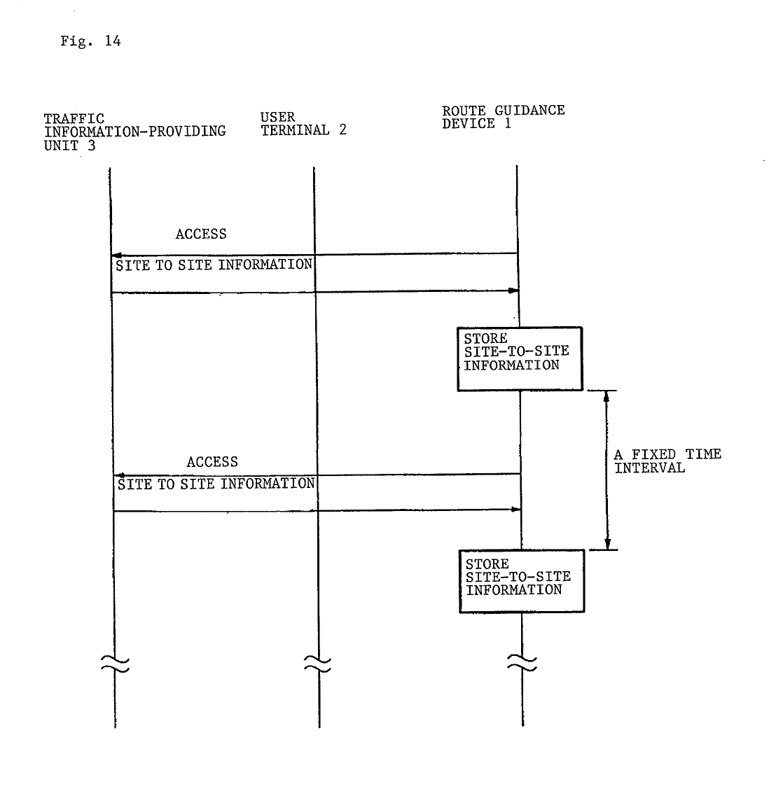

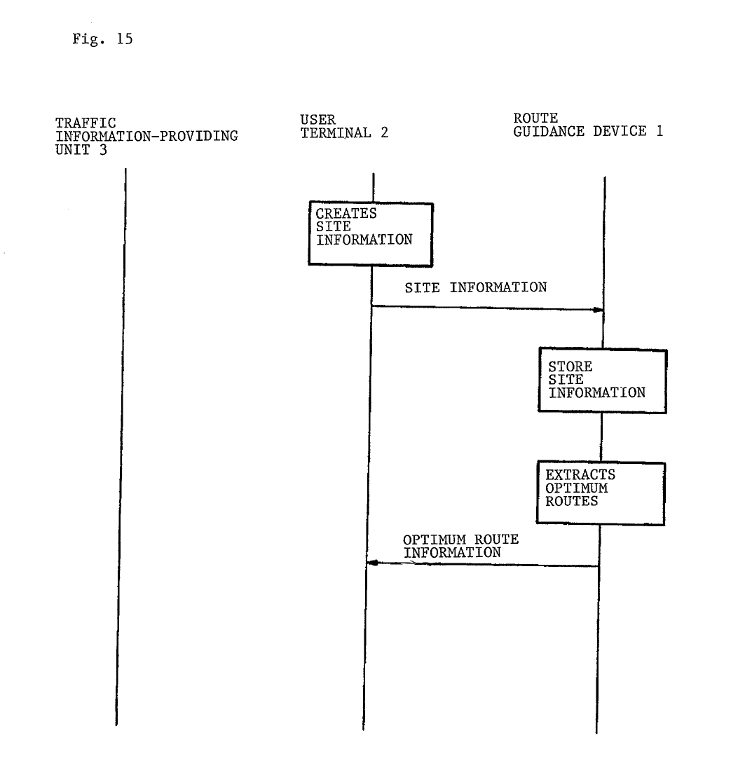

FIG. 14 is a sequence chart showing an example of the operation of periodically updating site-to-site information, and FIG. 15 is a sequence chart showing an example of extracting optimum routes in such a case.

As shown in FIG. 14, route guidance device 1 accesses traffic information-providing device 3 to obtain site-to-site information at a fixed time interval and updates the content of site-to-site information storage unit 16. Site-to-site information of route guidance device 1 is therefore always kept up-to-date.

As shown in FIG. 15, when site information is reported from user terminal 2 to route guidance device 1, route guidance device 1 extracts the optimum routes using the periodically updated site-to-site information stored in site-to-site information storage unit 16 and reports the extracted optimum routes to user terminal 2.

Since the site-to-site information are thus periodically updated, route guidance device 1 does not need to access traffic information-providing device 3 with each extraction of optimum routes, and the time required for extraction of routes therefore is reduced.

Storage unit 14 of route guidance device 1 (site information storage unit 15, site-to-site information storage unit 16, and map information storage unit 17) is a computer readable/writable recording medium that is realized by a hard disk device, a magneto-optical disk device, nonvolatile memory such as flash memory, volatile memory such as RAM (Random Access Memory), or a combination of these memory types. Processor 10 (site information-receiving unit 11, site-to-site information input unit 12, and optimum route extraction unit 13) may be realized by dedicated hardware, or alternatively, by recording a program for realizing these functions onto a computer-readable/writable recording medium, reading the program that has been recorded onto this recording medium into a computer system, and then executing the program. The computer-readable recording medium refers to a recording medium such as a floppy disk, magneto-optical disk, or CD-ROM and storage devices such as a hard disk device that is incorporated in a computer system. In cases such as when a program is sent by way of the Internet, a computer-readable recording medium further includes an entity that dynamically holds a program during a short period of time (a transmission medium or a transmission wave), and entities that hold a program for a fixed time in such cases, such as the volatile memory in a computer system that functions as a server.

While preferred embodiments of the present invention have been described using specific terms, such description is for illustrative purposes only, and it is to be understood that changes and variations may be made without departing from the spirit or scope of the following claims.

What is claimed is:

1. A method of offering to a user by way of the Internet an optimum route when a plurality of sites are to be visited; said method comprising steps of:
storing in advance map information that includes information regarding the time required to travel on roads on a map;
receiving, by way of said Internet, site information that is information indicating a plurality of sites that are to be visited, and storing said site information;
obtaining, by way of said Internet, site-to-site information that includes information regarding real-time traffic conditions of said roads, and storing said site-to-site information;
extracting an optimum route for visiting a plurality of said sites in the shortest time based on said map information, said site information, and said site-to-site information; and
reporting the extracted optimum route to said user by way of said Internet.

2. A method of offering to a user by way of the Internet an optimum route when a plurality of sites are to be visited, said method comprising steps of:
storing in advance map information that includes information regarding distances along roads on a map;
receiving, by way of said Internet, site information that includes information indicating a plurality of sites that are to be visited, and storing said site information;
obtaining, by way of said Internet, site-to-site information that includes information regarding real-time traffic conditions of said roads, and storing said site-to-site information;
extracting an optimum route for visiting a plurality of said sites by the shortest distance based on said map information, said site information, and said site-to-site information; and
reporting the extracted optimum route to said user by way of said Internet.

3. A method according to claim 1, wherein said site information includes the location of departure of said user, the location of each of said sites, and designated delivery time blocks, which are time blocks in which articles are to be delivered to said sites that are set according to necessity;
and wherein said step of extracting an optimum route extracts a route for visiting said sites that starts from said location of departure and arrives at sites in said designated delivery time blocks that have been set.

4. A method according to claim 2, wherein said site information includes the location of departure of said user, the location of each of said sites, and designated delivery time blocks, which are time blocks in which articles are to be delivered to said sites that are set according to necessity;
and wherein said step of extracting an optimum route extracts a route for visiting said sites that starts from said location of departure and arrives at sites in said designated delivery time blocks that have been set.

5. A method according to claim 1, wherein said step of extracting an optimum route uses, in the extraction of an optimum route, said site information and site-to-site information that are stored and that have been used in a previous extraction of an optimum route.

6. A method according to claim 2, wherein said step of extracting an optimum route uses, in the extraction of an optimum route, said site information and site-to-site information that are stored and that have been used in a previous extraction of an optimum route.

7. A method according to claim 1, wherein said step of extracting an optimum route extracts an optimum route that does not pass by way of a road having a traffic blockage, and moreover, that considers the time to travel by way of a road having alternating one-way traffic or congested traffic to be a prescribed time greater than the travel time during normal conditions.

8. A method according to claim 2, wherein said step of extracting an optimum route extracts the optimum route having the shortest distance such that the route does not pass by way of a road having a traffic blockage.

9. A system for offering to a user by way of the Internet an optimum route when a plurality of sites are to be visited, said system comprising:
a route guidance device having means for storing in advance map information that includes information regarding the time required to travel on roads on a map, means for receiving, by way of said Internet, site information, which is information indicating said sites that are to be visited and storing said site information, means for receiving, by way of said Internet, site-to-site information that includes information regarding real-time traffic conditions of said roads, and storing said site-to-site information, means for extracting an optimum route for visiting a plurality of said sites in the shortest time based on said map information, said site information, and said site-to-site information, and means for sending the information of said optimum route by way of said Internet;
a user terminal for producing at least a portion of said site information and sending site information to said route guidance device, and for receiving information of said optimum route that has been sent from said route guidance device; and
a traffic information-providing device for producing at least a portion of said site-to-site information and sending site-to-site information to said route guidance device.

10. A route guidance system for offering to a user by way of the Internet an optimum route when a plurality of sites are to be visited, said system comprising:
a route guidance device having means for storing in advance map information that includes information regarding the distances along roads on a map, means for receiving, by way of said Internet, site information that includes information indicating said sites that are to be visited and storing said site information, means for obtaining, by way of said Internet, site-to-site information that includes information regarding real-time traffic conditions of said roads and storing said site-to-site information, means for extracting an optimum route for visiting a plurality of said sites by the shortest distance based on said map information, said site information, and said site-to-site information; and means for sending the information of said optimum route by way of said Internet;
a user terminal for producing at least a portion of said site information and sending site information to said route guidance device, and for receiving information of said optimum route that has been sent from said route guidance device; and
a traffic information-providing device for producing at least a portion of said site-to-site information and sending site-to-site information to said route guidance device.

11. A system according to claim 9, wherein said site information includes the location of departure of said user, the location of each of said sites, and designated delivery time blocks, which are time blocks in which articles are to be delivered to said sites that are set according to necessity;
and wherein said means for extracting an optimum route extracts an optimum route for visiting said sites that starts from said location of departure and arrives at sites in said designated delivery time blocks that have been set.

12. A system according to claim 10, wherein said site information includes the location of departure of said user, the location of each of said sites, and designated delivery time blocks, which are time blocks in which articles are to be delivered to said sites that are set according to necessity;
and wherein said means for extracting an optimum route extracts an optimum route for visiting said sites that starts from said location of departure and arrives at sites in said designated delivery time blocks that have been set.

13. A system according to claim 9, wherein said means for extracting an optimum route uses, in the extraction of an optimum route, said site information and site-to-site information that are stored and that have been used in a previous extraction of an optimum route.

14. A system according to claim 10, wherein said means for extracting an optimum route uses, in the extraction of an optimum route, said site information and site-to-site information that are stored and that have been used in a previous extraction of an optimum route.

15. A system according to claim 9, wherein said means for extracting an optimum route extracts an optimum route that does not pass by way of a road having a traffic blockage, and moreover, considers the time to travel by way of a road having alternating one-way traffic or congested traffic to be a prescribed time greater than the travel time during normal conditions.

16. A system according to claim 10, wherein said means for extracting an optimum route extracts the optimum route having the shortest distance such that the route does not pass by way of a road having a traffic blockage.

17. A device for offering to a user by way of the Internet an optimum route when a plurality of sites are to be visited; said device comprising:
a map information storage means for storing in advance map information that includes information regarding the time required to travel along roads on a map;
a site information storage means for storing site information, which is information indicating a plurality of sites that are to be visited;
a site information-receiving means for receiving said site information by way of said Internet and storing said site information in said site information storage means;
a site-to-site information storage means for storing site-to-site information that includes information regarding real-time traffic conditions of said roads;
a site-to-site information input means for obtaining said site-to-site information by way of said Internet and storing said site-to-site information in said site-to-site storage means; and
an optimum route extraction means for extracting an optimum route for visiting a plurality of said sites in the shortest time based on said map information, said site information, and said site-to-site information, and reporting the information of the optimum route to said user by way of said Internet.

18. A device for offering to a user by way of the Internet an optimum route when a plurality of sites are to be visited; said device comprising:
a map information storage means for storing in advance map information that includes information regarding the distances along roads on a map;
a site information storage means for storing site information, which is information indicating a plurality of sites that are to be visited;
a site information-receiving means for receiving said site information by way of said Internet and storing said site information in said site information storage means;
a site-to-site information storage means for storing site-to-site information that includes information regarding real-time traffic conditions of said roads;
a site-to-site information input means for obtaining said site-to-site information by way of said Internet and storing said site-to-site information in said site-to-site storage means; and
an optimum route extraction means for extracting an optimum route for visiting a plurality of said sites by the shortest distance based on said map information, said site information, and said site-to-site information, and reporting the information of the optimum route to said user by way of said Internet.

19. A computer program for enabling a computer to offer to a user by way of the Internet an optimum route when a plurality of sites are to be visited;
said computer program including software commands for causing a computer to carry out prescribed operations; said prescribed operations comprising steps of:
receiving, by way of said Internet, site information that is information indicating a plurality of sites that are to be visited, and storing said site information in a storage medium;
receiving, by way of said Internet, site-to-site information that includes information regarding real-time traffic conditions of roads to be traveled along and storing said site-to-site information in a storage medium;
extracting an optimum route for visiting a plurality of said sites in the shortest time based on map information that includes information regarding the time required to travel along roads on a map, said site information, and said site-to-site information; and reporting information of the extracted optimum route to said user by way of said Internet.

20. A computer program for enabling a computer to offer to a user by way of the Internet an optimum route when a plurality of sites are to be visited;
said computer program including software commands for causing a computer to carry out prescribed operations; said prescribed operations comprising steps of:
receiving, by way of said Internet, site information that is information indicating a plurality of sites that are to be visited, and storing said site information in a storage medium;
receiving, by way of said Internet, site-to-site information that includes information regarding real-time traffic conditions of roads to be traveled along and storing said site-to-site information in a storage medium;
extracting an optimum route for visiting a plurality of said sites by the shortest distance based on map information that includes information regarding distances along roads on a map, said site information, and said site-to-site information; and
reporting information of the extracted optimum route to said user by way of said Internet.
